(19) United States
(12) Patent Application Publication
(10) Pub. No.: US 2020/0082269 A1
(43) Pub. Date: Mar. 12, 2020

(54) MEMORY EFFICIENT NEURAL NETWORKS

(71) Applicant: NVIDIA CORPORATION, Santa Clara, CA (US)

(72) Inventors: Shuang GAO, Newark, CA (US); Hao WU, Santa Clara, CA (US); John ZEDLEWSKI, San Francisco, CA (US)

(21) Appl. No.: 16/373,447

(22) Filed: Apr. 2, 2019

Related U.S. Application Data
(60) Provisional application No. 62/730,508, filed on Sep. 12, 2018.

(51) Int. Cl. G06N 3/08; G06F 7/57; G06N 5/04; G06N 3/04

(52) U.S. Cl. CPC G06N 3/082; G06N 3/084; G06N 3/0454; G06N 5/04; G06F 7/57

(57) ABSTRACT

One embodiment of a method includes performing one or more activation functions in a neural network using weights that have been quantized from floating point values to values that are represented using fewer bits than the floating point values. The method further includes performing a first quantization of the weights from the floating point values to the values that are represented using fewer bits than the floating point values after the floating point values are updated using a first number of forward-backward passes of the neural network using training data. The method further includes performing a second quantization of the weights from the floating point values to the values that are represented using fewer bits than the floating point values after the floating point values are updated using a second number of forward-backward passes of the neural network following the first quantization of the weights.

### CROSS-REFERENCE TO RELATED APPLICATIONS

This application claims priority benefit of the United States Provisional Patent Application titled, “Training Quantized Deep Neural Networks,” filed on Sep. 12, 2018 and having Ser. No. 62/730,508. The subject matter of this related application is hereby incorporated herein by reference.

### BACKGROUND

Neural networks have computation-heavy layers such as convolutional layers and/or fully-connected layers. Such neural networks are commonly trained and deployed using full-precision arithmetic. The full-precision arithmetic is computationally complex and has a significant memory footprint, making the execution of neural networks time and memory intensive.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1A illustrates a system configured to implement one or more aspects of various embodiments.

FIG. 1B illustrates inference and/or training logic used to perform inferencing and/or training operations associated with one or more embodiments.

FIG. 1C illustrates the inference and/or training logic, according to other various embodiments.

FIG. 2 is a more detailed illustration of the training engine and inference engine of FIG. 1, according to various embodiments.

FIG. 3 is a flow diagram of method steps for quantizing weights in a neural network, according to various embodiments.

FIG. 4 is a flow diagram of method steps for quantizing activations in a neural network, according to various embodiments.

FIG. 5 is a block diagram illustrating a computer system configured to implement one or more aspects of various embodiments.

FIG. 6 is a block diagram of a parallel processing unit (PPU) included in the parallel processing subsystem of FIG. 5, according to various embodiments.

FIG. 7 is a block diagram of a general processing cluster (GPC) included in the parallel processing unit (PPU) of FIG. 6, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

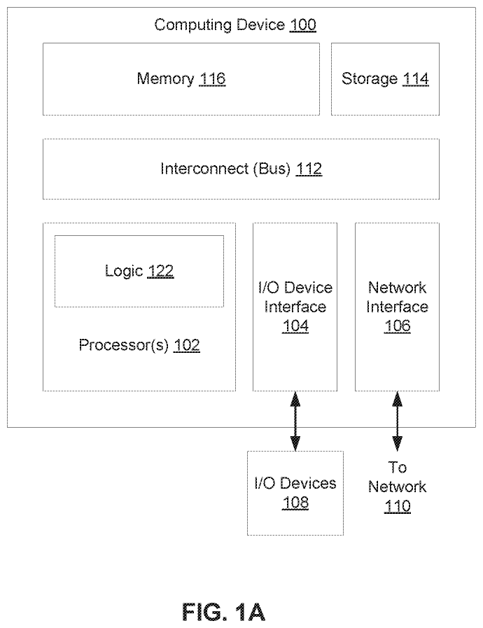

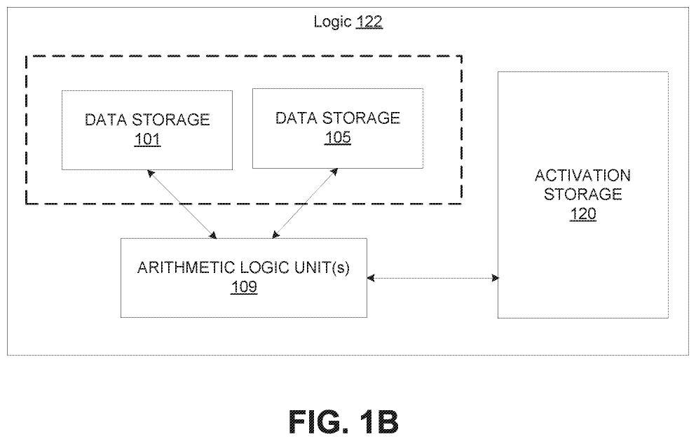

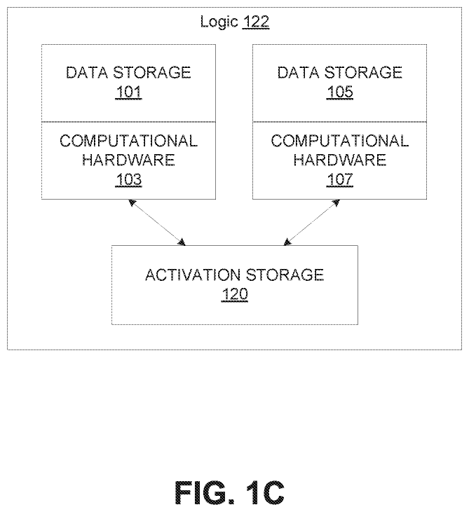

FIG. 1A illustrates a computing device 100 configured to implement one or more aspects of various embodiments. In one embodiment, computing device 100 may be a desktop computer, a laptop computer, a smart phone, a personal digital assistant (PDA), tablet computer, or any other type of computing device configured to receive input, process data, and optionally display images, and is suitable for practicing one or more embodiments. It is noted that the computing device described herein is illustrative and that any other technically feasible configurations fall within the scope of the present disclosure.

In one embodiment, computing device 100 includes, without limitation, an interconnect (bus) 112 that connects one or more processing units 102, an input/output (I/O) device interface 104 coupled to one or more input/output (I/O) devices 108, memory 116, a storage 114, and a network interface 106. Processing unit(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In one embodiment, processing unit(s) 102 may be any technically feasible hardware unit capable of processing data and/or executing software applications. In one embodiment, the computing elements shown in computing device 100 may correspond to a physical computing system (e.g., a system in a data center) or may be a virtual computing instance executing within a computing cloud. In one embodiment, processing unit(s) 102 are configured with logic 122. Details regarding various embodiments of logic 122 are provided below in conjunction with FIGS. 1B and/or 1C.

In one embodiment, I/O devices 108 include devices capable of providing input, such as a keyboard, a mouse, a touch-sensitive screen, and so forth, as well as devices capable of providing output, such as a display device. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

In one embodiment, network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

In one embodiment, storage 114 includes non-volatile storage for applications and data, and may include fixed or removable disk drives, flash memory devices, and CD-ROM, DVD-ROM, Blu-Ray, HD-DVD, or other magnetic, optical, or solid state storage devices. Training engine 201 and inference engine 221 may be stored in storage 114 and loaded into memory 116 when executed.

In one embodiment, memory 116 includes a random access memory (RAM) module, a flash memory unit, or any other type of memory unit or combination thereof. Processing unit(s) 102, I/O device interface 104, and network interface 106 are configured to read data from and write data to memory 116. Memory 116 includes various software programs that can be executed by processor(s) 102 and application data associated with said software programs.

FIG. 1B illustrates inference and/or training logic 122 used to perform inferencing and/or training operations associated with one or more embodiments.

In one embodiment, the inference and/or training logic 122 may include, without limitation, a data storage 101 to store forward and/or output weight and/or input/output data corresponding to neurons or layers of a neural network trained and/or used for inferencing in aspects of one or more embodiments. In one embodiment the data storage 101 stores weight parameters and/or input/output data of each layer of a neural network trained or used in conjunction with one or more embodiments during the forward propagation of input/output data and/or weight parameters during training and/or inferencing using aspects of one or more embodiments. In one embodiment, any portion of the data storage 101 may be included with other on-chip or off-chip data storage, including a processor's L1, L2, or L3 cache or system memory. In one embodiment, any portion of the data storage 101 may be internal or external to one or more processors or other hardware logic devices or circuits. In one embodiment, the data storage 101 may be cache memory, dynamic randomly addressable memory (“DRAM”), static randomly addressable memory (“SRAM:), non-volatile memory (e.g., Flash memory), or other storage. In one embodiment, the choice of whether the data storage 101 is internal or external to a processor, for example, or comprised of DRAM, SRAM, Flash or some other storage type may depend on available storage on-chip versus off-chip, latency requirements of the training and/or inferencing functions being performed, batch size of the data used in inferencing and/or training of a neural network, or some combination of these factors.

In one embodiment, the inference and/or training logic 122 may include, without limitation, a data storage 105 to store backward and/or output weight and/or input/output data corresponding to neurons or layers of a neural network trained and/or used for inferencing in aspects of one or more embodiments. In one embodiment, the data storage 105 stores weight parameters and/or input/output data of each layer of a neural network trained or used in conjunction with one or more embodiments during the backward propagation of input/output data and/or weight parameters during training and/or inferencing using aspects of one or more embodiments. In one embodiment, any portion of the data storage 105 may be included with other on-chip or off-chip data storage, including a processor's L1, L2, or L3 cache or system memory. In one embodiment, any portion of the data storage 105 may be internal or external to on one or more processors or other hardware logic devices or circuits. In one embodiment, the data storage 105 may be cache memory, DRAM, SRAM, non-volatile memory (e.g., Flash memory), or other storage. In one embodiment, the choice of whether the data storage 105 is internal or external to a processor, for example, or comprised of DRAM, SRAM, Flash or some other storage type may depend on available storage on-chip versus off-chip, latency requirements of the training and/or inferencing functions being performed, batch size of the data used in inferencing and/or training of a neural network, or some combination of these factors.

In one embodiment, the data storage 101 and the data storage 105 may be separate storage structures. In one embodiment, the data storage 101 and the data storage 105 may be the same storage structure. In one embodiment, the data storage 101 and the data storage 105 may be partially the same storage structure and partially separate storage structures. In one embodiment, any portion of the data storage 101 and the data storage 105 may be included with other on-chip or off-chip data storage, including a processor's L1, L2, or L3 cache or system memory.

In one embodiment, the inference and/or training logic 122 may include, without limitation, one or more arithmetic logic unit(s) (“ALU(s)”) 109 to perform logical and/or mathematical operations indicated by training and/or inference code, the result of which may result in activations (e.g., output values from layers or neurons within a neural network) stored in an activation storage 120 that are functions of input/output and/or weight parameter data stored in the data storage 101 and/or the data storage 105. In one embodiment, activations stored in the activation storage 120 are generated according to linear algebraic mathematics performed by the ALU(s) 109 in response to performing instructions or other code, wherein the weight values stored in the data storage 105 and/or the data 101 are used as operands along with other values, such as bias values, gradient information, momentum values, or other parameters or hyperparameters, any or all of which may be stored in the data storage 105 or the data storage 101 or another storage on or off-chip. In one embodiment, the ALU(s) 109 are included within one or more processors or other hardware logic devices or circuits, whereas in another embodiment, the ALU(s) 109 may be external to a processor or other hardware logic device or circuit that uses them (e.g., a co-processor). In one embodiment, the ALUs 109 may be included within a processor's execution units or otherwise within a bank of ALUs accessible by a processor's execution units either within the same processor or distributed between different processors of different types (e.g., central processing units, graphics processing units, fixed function units, etc.). In one embodiment, the data storage 101, the data storage 105, and the activation storage 120 may be on the same processor or other hardware logic device or circuit, whereas in another embodiment, they may be in different processors or other hardware logic devices or circuits, or some combination of same and different processors or other hardware logic devices or circuits. In one embodiment, any portion of the activation storage 120 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In one embodiment, the activation storage 120 may be cache memory, DRAM, SRAM, non-volatile memory (e.g., Flash memory), or other storage. In one embodiment, the activation storage 120 may be completely or partially within or external to one or more processors or other logical circuits. In one embodiment, the choice of whether the activation storage 120 is internal or external to a processor, for example, or comprised of DRAM, SRAM, Flash or some other storage type may depend on available storage on-chip versus off-chip, latency requirements of the training and/or inferencing functions being performed, batch size of the data used in inferencing and/or training of a neural network, or some combination of these factors. In one embodiment, the inference and/or training logic 122 illustrated in FIG. 1B may be used in conjunction with an application-specific integrated circuit (“ASIC”), such as Tensorflow® Processing Unit from Google or a Nervana® Q “Lake Crest”) processor from Intel Corp. In one embodiment, the inference and/or training logic 122 illustrated in FIG. 1B may be used in conjunction with central processing unit (“CPU”) hardware, graphics processing unit (“GPU”) hardware or other hardware, such as field programmable gate arrays (“FPGAs”).

FIG. 1C illustrates the inference and/or training logic 122, according to other various embodiments. In one embodiment, the inference and/or training logic 122 may include, without limitation, hardware logic in which computational resources are dedicated or otherwise exclusively used in conjunction with weight values or other information corresponding to one or more layers of neurons within a neural network. In one embodiment, the inference and/or training logic 122 illustrated in FIG. 1C may be used in conjunction with an application-specific integrated circuit (ASIC), such as Tensorflow® Processing Unit from Google or a Nervana®(e.g., “Lake Crest”) processor from Intel Corp. In one embodiment, the inference and/or training logic 122 illustrated in FIG. 1C may be used in conjunction with central processing unit (CPU) hardware, graphics processing unit (GPU) hardware or other hardware, such as field programmable gate arrays (FPGAs). In one embodiment, the inference and/or training logic 122 includes, without limitation, the data storage 101 and the data storage 105, which may be used to store weight values and/or other information, including bias values, gradient information, momentum values, and/or other parameter or hyperparameter information. In one embodiment illustrated in FIG. 1C, each of the data storage 101 and the data storage 105 is associated with a dedicated computational resource, such as computational hardware 103 and computational hardware 107, respectively. In one embodiment, each of the computational hardware 103 and the computational hardware 107 comprises one or more ALUs that perform mathematical functions, such as linear algebraic functions, only on the information stored in the data storage 101 and the data storage 105, respectively, the result of which is stored in the activation storage 120.

In one embodiment, each of the data storage 101 and 105 and the corresponding computational hardware 103 and 107, respectively, correspond to different layers of a neural network, such that the resulting activation from one “storage/computational pair 101/103” of the data storage 101 and the computational hardware 103 is provided as an input to the next “storage/computational pair 105/107” of the data storage 105 and the computational hardware 107, in order to mirror the conceptual organization of a neural network. In one embodiment, each of the storage/computational pairs 101/103 and 105/107 may correspond to more than one neural network layer. In one embodiment, additional storage/computation pairs (not shown) subsequent to or in parallel with the storage computation pairs 101/103 and 105/107 may be included in the inference and/or training logic 122.

### Memory Efficient Neural Networks

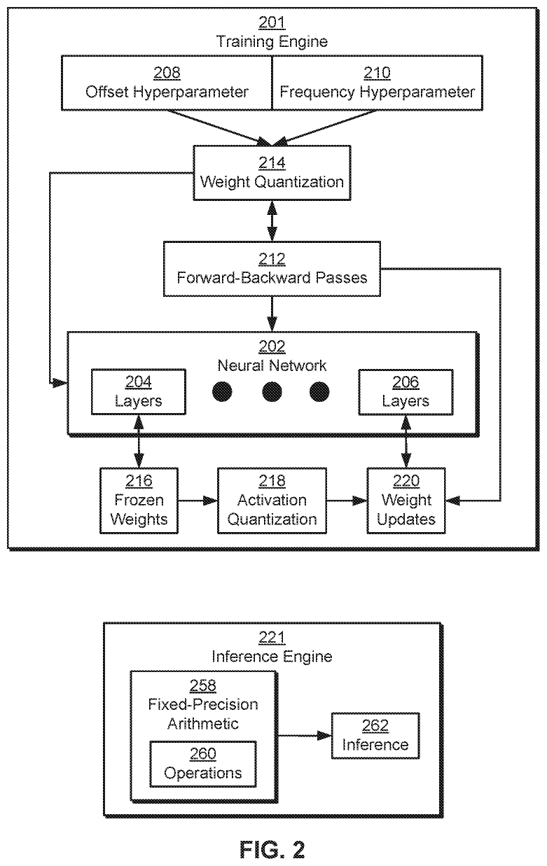

FIG. 2 is an illustration of a training engine 201 and an inference engine 221, according to various embodiments. In various embodiments, training engine 201, inference engine 221, and/or portions thereof may be executed within processing unit(s) 102 in conjunction with logic 122.

In one embodiment, training engine 201 includes functionality to generate machine learning models using quantized parameters. For example, training engine 201 may periodically quantize weights in a neural network from floating point values to values that are represented using fewer bits than before quantization. In one embodiment, the quantized weights are generated after a certain whole number of forward-backward passes used to update the weights during training of the neural network, and before any successive forward-backward passes are performed to further train the neural network. In one embodiment, training engine 201 may also quantize individual activation layers of the neural network in a successive fashion, starting with layers closest to the input layer of the neural network and proceeding until layers closest to the output layer of the neural network are reached. When a given activation layer of the neural network is quantized, weights in previous layers used to calculate inputs to the activation layer are frozen, and weights in subsequent layers of the neural network are fine-tuned (also referred to herein as “adjusted” or “modified”) based on the quantized outputs of the activation layer.

In one embodiment, inference engine 221 executes machine learning models produced by training engine 201 using quantized parameters and/or intermediate values in the machine learning models. For example, inference engine 221 may use fixed-precision arithmetic to combine the quantized weights in each layer of a neural network with quantized activation outputs from the previous layer of the neural network until one or more outputs are produced by the neural network.

In the embodiment shown, training engine 201 uses a number of forward-backward passes 214 with weight quantization 214 and activation quantization 218 to train a neural network 202. Neural network 202 can be any technically feasible form of machine learning model that utilizes artificial neurons and/or perceptrons. For example, neural network 202 may include one or more recurrent neural networks (RNNs), convolutional neural networks (CNNs), deep neural networks (DNNs), deep convolutional networks (DCNs), deep belief networks (DBNs), restricted Boltzmann machines (RBMs), long-short-term memory (LSTM) units, gated recurrent units (GRUs), generative adversarial networks (GANs), self-organizing maps (SOMs), and/or other types of artificial neural networks or components of artificial neural networks. In another example, neural network 202 may include functionality to perform clustering, principal component analysis (PCA), latent semantic analysis (LSA), Word2vec, and/or another unsupervised learning technique. In a third example, neural network 202 may implement the functionality of a regression model, support vector machine, decision tree, random forest, gradient boosted tree, naïve Bayes classifier, Bayesian network, hierarchical model, and/or ensemble model.

In one embodiment, neurons in neural network 202 are aggregated into a number of layers 204-206. For example, layers 204-206 may include an input layer, an output layer, and one or more hidden layers between the input layer and output layer. In another example, layers 204-206 may include one or more convolutional layers, batch normalization layers, activation layers, pooling layers, fully connected layers, recurrent layers, loss layers, ReLu layers, and/or other types of neural network layers.

In some embodiments, training engine 201 trains neural network 202 by using rounds of forward-backward passes 214 to update weights in layers 204-206 of neural network 202. In some embodiments, each forward-backward pass includes a forward propagation step followed by a backward propagation step. The forward propagation step propagates a “batch” of inputs to neural network 202 through successive layers 204-206 of neural network 202 until a batch of corresponding outputs is generated by neural network 202. The backward propagation step proceeds backwards through neural network 202, starting with the output layer and proceeding until the first layer is reached. At each layer, the backward propagation step calculates the gradient (derivative) of a loss function that measures the difference between the batch of outputs and the corresponding desired outputs with respect to each weight in the layer. The backward propagation step then updates the weights in the layer in the direction of the negative of the gradient to reduce the error of neural network 202.

In one or more embodiments, training engine 201 performs weight quantization 214 and activation quantization 218 during training of neural network 202. In these embodiments, weight quantization 214 includes converting some or all weights in neural network 202 from full-precision (e.g., floating point) values into values that are represented using fewer bits than before weight quantization 214, and activation quantization 218 includes converting some or all activation outputs from neurons and/or layers 204-206 of neural network 202 from full-precision values into values that are represented using fewer bits than before activation quantization 218. For example, training engine 201 may “bucketize” floating point values in weights and/or activation outputs of neural network 202 into a certain number of bins representing different ranges of floating point values, with the number of bins determined based on the bit width of the corresponding quantized values. In another example, training engine 201 may use clipping, rounding, vector quantization, probabilistic quantization, and/or another type of quantization technique to perform weight quantization 214 and/or activation quantization 218.

In some embodiments, training engine 201 maintains differentiability of the loss function during training of neural network 202 by performing weight quantization 214 after a certain whole number of forward-backward passes 212 have been used to update full-precision weights in layers 204-206 of neural network 202. In these embodiments, an offset hyperparameter 208 delays weight quantization 214 until the weights have been updated over a certain initial number of forward-backward passes 212, and a frequency hyperparameter 210 specifies a frequency with which weight quantization 214 is to be performed after the delay. Offset hyperparameter 208 may be selected to prevent weight quantization 214 from interfering with large initial changes to neural network 202 weights at the start of the training process, and frequency hyperparameter 208 may be selected to allow subsequent incremental changes in weights to accumulate before the weights are quantized.

For example, offset hyperparameter 208 may specify a numeric “training step index” representing an initial number of forward-backward passes 212 to be performed before weight quantization 214 is performed, and frequency hyperparameter 210 may specify a numeric frequency representing a number of consecutive forward-backward passes 212 to be performed in between each weight quantization 214. Thus, if offset hyperparameter 208 is set to a value of 200 and frequency hyperparameter 210 is set to a value of 25, training engine 201 may perform the first weight quantization 214 after the first 200 forward-backward passes 212 of neural network 202 and perform subsequent weight quantization 214 after every 25 forward-backward passes 212 of neural network 202.

In one or more embodiments, training engine 201 performs activation quantization 218 after neural network 202 has been trained until a local minimum in the loss function is found and/or the gradient of the loss function converges, and weights in neural network 202 have been quantized. For example, training engine 201 may perform activation quantization 218 after weights in neural network 202 are fully trained and quantized using a number of forward-backward passes 212, offset hyperparameter 208, and/or frequency hyperparameter 210. In another example, training engine 201 may perform activation quantization 218 after neural network 202 is trained and weights in neural network 202 are quantized using another technique.

In some embodiments, training engine 201 performs activation quantization 218 on activation outputs of individual layers 204-206 in neural network 202 in a successive fashion, starting with layers 204 closer to the input of neural network 202 and proceeding to layers 206 closer to the output of neural network 202. For example, training engine 201 may perform multiple stages of activation quantization 218, with each stage affecting one or more layers 204-206 that generate activation outputs in neural network 202 (e.g., a fully connected layer, a convolutional layer and a batch normalization layer, etc.).

In one or more embodiments, each stage of activation quantization 218 is accompanied by a fine-tuning process that involves the use of frozen weights 216 in layers 204 preceding the quantized activation outputs and weight updates 220 in layers 206 following the quantized activation outputs. For example, training engine 201 may freeze quantized weights in one or more convolutional blocks, with each convolutional block containing a convolutional layer followed by a batch normalization layer. Training engine 201 may also add an activation quantization layer to the end of each frozen convolutional block to quantize the activation output generated by the convolutional block(s). Training engine 201 may further execute additional forward-backward passes 212 that update weights in additional convolutional blocks and/or other layers 204-206 following the frozen convolutional block(s) based on differences between the output generated by neural network 202 from a set of inputs and the expected output associated with the inputs.

After the weights in layers following the most recent activation quantization 218 have been updated to tune the performance of neural network 202 with respect to the quantized activation output, training engine 201 may repeat the process with subsequent convolutional blocks and/or layers 206 in neural network 202 until the output layer and/or another layer of neural network 202 is reached. Because training engine 201 quantizes activation outputs in neural network 202 in the forward direction and performs weight updates 220 only for layers following the quantized activation outputs, training engine 201 maintains the differentiability of the loss function during activation quantization 218 and the corresponding fine-tuning of neural network 202.

In one or more embodiments, training engine 201 performs additional weight quantization 214 during the fine tuning process that performs full-precision weight updates 220 of layers 206 following a latest activation quantization 218 in neural network 202. For example, training engine 201 may apply weight quantization 214 to layers 206 following activation quantization 218 after one or more rounds of forward-backward passes 212 are used to perform floating-point weight updates 220 in the layers.

In some embodiments, training engine 201 delays weight quantization 214 in layers 206 following the latest activation quantization 218 according to a value of offset hyperparameter 210 that specifies an initial number of forward-backward passes 212 of full-precision weight updates 220 to be performed before the corresponding weights are quantized. Training engine 201 may also, or instead, periodically perform weight quantization 214 in layers 206 following the latest activation quantization 218 according to a value of frequency hyperparameter 210 that specifies a certain consecutive number of forward-backward passes 212 of full-precision weight updates 220 to be performed in between successive rounds of weight quantization 214. In these embodiments, values of offset hyperparameter 208 and frequency hyperparameter 210 may be identical to or different from the respective values of offset hyperparameter 208 and frequency hyperparameter 210 used in weight quantization 214 of all weights in neural network 202 described above.

In some embodiments, training engine 201 omits weight quantization 214 and/or activation quantization 218 for certain layers of neural network 202. For example, training engine 201 may generate floating point representations of weights and/or activation outputs associated with the output layer of neural network 202 and/or one or more layers 204-206 with which full-precision arithmetic is to be used.

In some embodiments, inference engine 221 uses fixed-precision arithmetic 258 to execute operations 260 that allow neural network 202 to perform inference 262 using quantized weights and/or activation outputs. For example, inference engine 221 may perform convolution, matrix multiplication, and/or other operations 260 that generate output of layers 204-206 in neural network 202 using quantized weights and/or activation outputs in neural network 202 instead of floating-point weights and/or activation outputs that require significantly more computational and/or storage resources. As a result, inference 262 performed using the quantized version of neural network 202 may be faster and/or more efficient than using a non-quantized version of neural network 202.

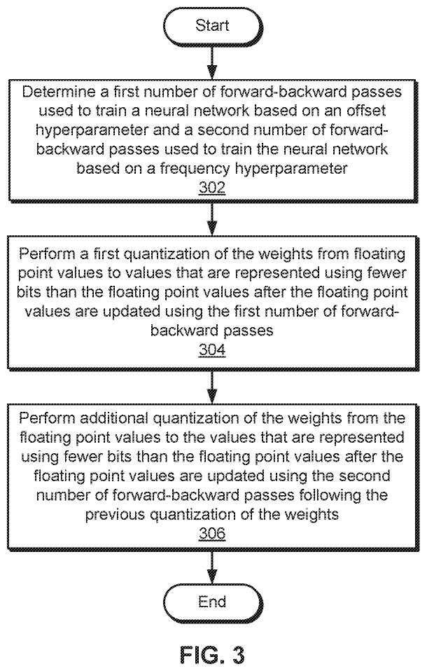

FIG. 3 is a flow diagram of method steps for quantizing weights in a neural network, according to various embodiments. Although the method steps are described in conjunction with the systems of FIGS. 1 and 2, persons skilled in the art will understand that any system configured to perform the method steps in any order falls within the scope of the present disclosure.

As shown, training engine 201 determines 302 a first number of forward-backward passes used to train a neural network based on an offset hyperparameter and a second number of forward-backward passes used to train the neural network based on a frequency hyperparameter. For example, training engine 201 may obtain the first number of forward-backward passes as a numeric “training step index” representing an initial number of forward propagation and backward propagation passes to be performed before weights in the neural network are quantized. In another example, training engine 201 may obtain the second number of forward-backward passes as a numeric frequency representing a number of consecutive forward-backward passes to be performed in between each weight quantization after quantizing of the weights has begun.

Next, training engine 201 performs 304 a first quantization of the weights from floating point values to values that are represented using fewer bits than the floating point values after the floating point values are updated using the first number of forward-backward passes. For example, training engine 201 may delay initial quantization of the weights until full-precision versions of the weights have been updated over the first number of forward-backward passes. Training engine 201 may then quantize the weights by converting the full-precision values into values that represent bucketized ranges of the full-precision values.

Training engine 201 repeatedly performs 306 additional quantization of the weights from the floating point values to the values that are represented using fewer bits than the floating point values after the floating point values are updated using the second number of forward-backward passes following the previous quantization of the weights until training of the neural network is complete 308. For example, training engine 201 may perform full-precision updates of the weights during forward-backward passes following each quantization of the weights. Training engine 201 may also quantize the weights on a periodic basis according to the frequency hyperparameter (e.g., after the second number of forward-backward passes has been performed following the most recent weight quantization) until convergence is reached.

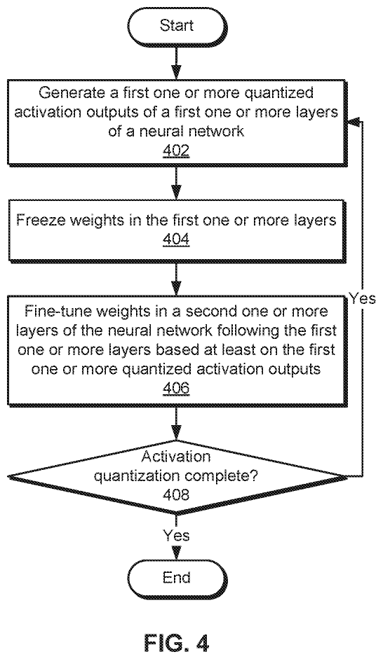

FIG. 4 is a flow diagram of method steps for quantizing activations in a neural network, according to various embodiments. Although the method steps are described in conjunction with the systems of FIGS. 1 and 2, persons skilled in the art will understand that any system configured to perform the method steps in any order falls within the scope of the present disclosure.

As shown, training engine 201 generates 402 a first one or more quantized activation outputs of a first one or more layers of a neural network. For example, training engine 201 may add an activation quantization layer to each layer and/or convolutional block in the first one or more layers that generates an activation output. The activation quantization layer may convert floating point activation outputs from the preceding layer into values that are represented using fewer bits than the floating point activation outputs.

Next, training engine 201 freezes 404 weights in the first one or more layers. For example, training engine 201 may freeze weights in the first one or more layers that have been quantized using the method steps described with respect to FIG. 3.

Training engine 201 then fine-tunes 406 weights in a second one or more layers of the neural network following the first one or more layers based at least on the first one or more quantized activation outputs. For example, training engine 201 may update floating point weights in layers following the frozen layers during a first number of forward-backward passes of the neural network using the first one or more quantized activation outputs and training data. Training engine 201 may determine the first number of forward-backward passes based on an offset hyperparameter associated with quantizing the weights during training of the neural network; after the first number of forward-backward passes has been performed, training engine 201 may perform a first quantization of the weights from the floating point values to values that are represented using fewer bits than the floating point values. After the weights have been quantized, training engine 201 may perform floating-point updates to the weights during a second number of forward-backward passes of the neural network. Training engine 201 may determine the second number of forward-backward passes based on a frequency hyperparameter associated with quantizing the weights during training of the neural network; after the second number of forward-backward passes has been performed, training engine 201 may perform a second quantization of the weights from the floating point values to the values that are represented using fewer bits than the floating point values.

Training engine 201 may continue generating quantized activation outputs of certain layers of the neural network, freezing weights in the layers, and fine-tuning weights in subsequent layers of the neural network until activation quantization in the neural network is complete 408. For example, training engine 201 may perform quantization activation in multiple stages, starting with layers near the input layer of the neural network and proceeding until the output layer of the neural network is reached. At each stage, training engine 201 may quantize one or more activation outputs following the quantized activation outputs from the previous stage and freeze weights in layers used to generate the quantized activation outputs. Training engine 201 may then update floating point weights in remaining layers of the neural network and/or quantize the updated weights after certain whole numbers of forward-backward passes of the remaining layers until the remaining layers have been tuned in response to the most recently quantized activation outputs.

### Example Hardware Architecture

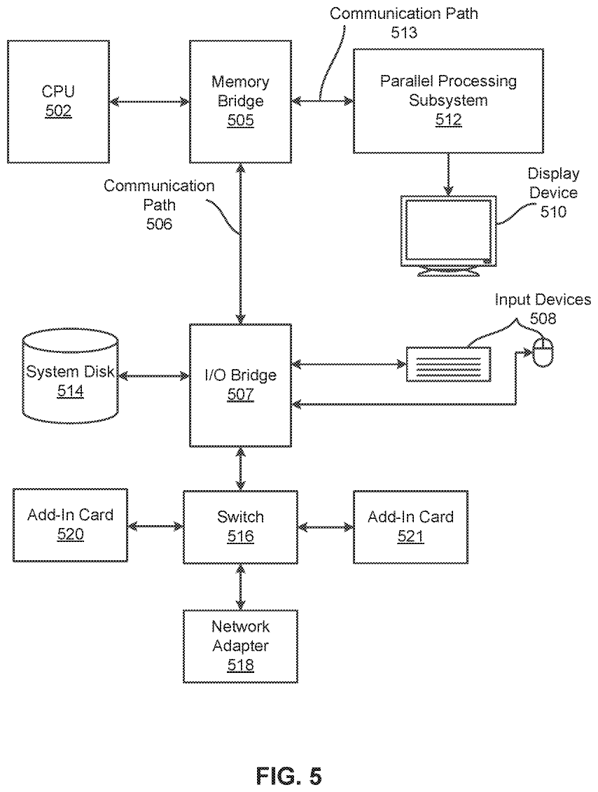

FIG. 5 is a block diagram illustrating a computer system 500 configured to implement one or more aspects of various embodiments. In some embodiments, computer system 500 is a server machine operating in a data center or a cloud computing environment that provides scalable computing resources as a service over a network. In some embodiments, computer system 500 implements the functionality of computing device 100 of FIG. 1.

In various embodiments, computer system 500 includes, without limitation, a central processing unit (CPU) 502 and a system memory 504 coupled to a parallel processing subsystem 512 via a memory bridge 505 and a communication path 513. Memory bridge 505 is further coupled to an I/O (input/output) bridge 507 via a communication path 506, and I/O bridge 507 is, in turn, coupled to a switch 516.

In one embodiment, I/O bridge 507 is configured to receive user input information from optional input devices 508, such as a keyboard or a mouse, and forward the input information to CPU 502 for processing via communication path 506 and memory bridge 505. In some embodiments, computer system 500 may be a server machine in a cloud computing environment. In such embodiments, computer system 500 may not have input devices 508. Instead, computer system 500 may receive equivalent input information by receiving commands in the form of messages transmitted over a network and received via the network adapter 518. In one embodiment, switch 516 is configured to provide connections between I/O bridge 507 and other components of the computer system 500, such as a network adapter 518 and various add-in cards 520 and 521.

In one embodiment, I/O bridge 507 is coupled to a system disk 514 that may be configured to store content and applications and data for use by CPU 502 and parallel processing subsystem 512. In one embodiment, system disk 514 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to I/O bridge 507 as well.

In various embodiments, memory bridge 505 may be a Northbridge chip, and I/O bridge 507 may be a Southbridge chip. In addition, communication paths 506 and 513, as well as other communication paths within computer system 500, may be implemented using any technically suitable protocols, including, without limitation, AGP (Accelerated Graphics Port), HyperTransport, or any other bus or point-to-point communication protocol known in the art.

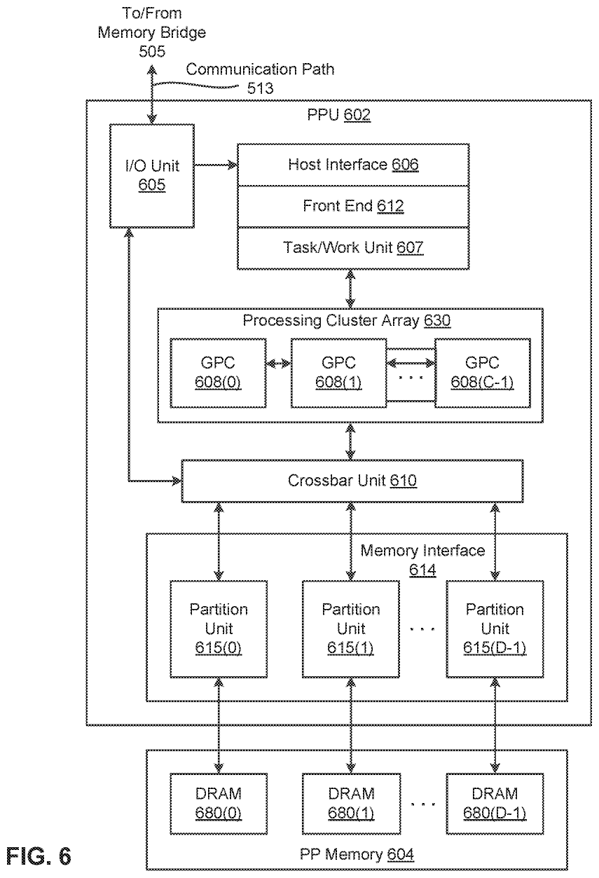

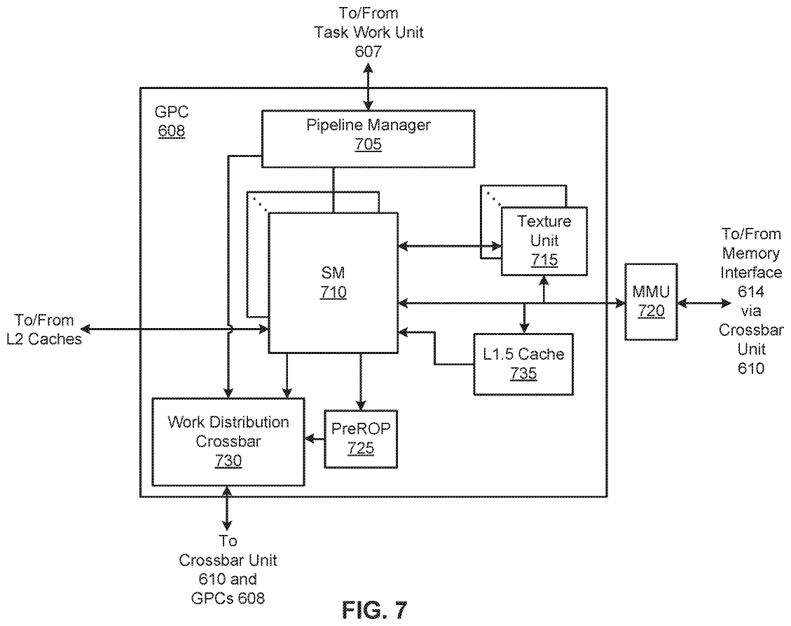

In some embodiments, parallel processing subsystem 512 comprises a graphics subsystem that delivers pixels to an optional display device 510 that may be any conventional cathode ray tube, liquid crystal display, light-emitting diode display, or the like. In such embodiments, the parallel processing subsystem 512 incorporates circuitry optimized for graphics and video processing, including, for example, video output circuitry. As described in greater detail below in conjunction with FIGS. 6 and 7, such circuitry may be incorporated across one or more parallel processing units (PPUs), also referred to herein as parallel processors, included within parallel processing subsystem 512.

In other embodiments, the parallel processing subsystem 512 incorporates circuitry optimized for general purpose and/or compute processing. Again, such circuitry may be incorporated across one or more PPUs included within parallel processing subsystem 512 that are configured to perform such general purpose and/or compute operations. In yet other embodiments, the one or more PPUs included within parallel processing subsystem 512 may be configured to perform graphics processing, general purpose processing, and compute processing operations. System memory 504 includes at least one device driver configured to manage the processing operations of the one or more PPUs within parallel processing subsystem 512.

In various embodiments, parallel processing subsystem 512 may be integrated with one or more of the other elements of FIG. 5 to form a single system. For example, parallel processing subsystem 512 may be integrated with CPU 502 and other connection circuitry on a single chip to form a system on chip (SoC).

In one embodiment, CPU 502 is the master processor of computer system 500, controlling and coordinating operations of other system components. In one embodiment, CPU 502 issues commands that control the operation of PPUs. In some embodiments, communication path 513 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of CPUs 502, and the number of parallel processing subsystems 512, may be modified as desired. For example, in some embodiments, system memory 504 could be connected to CPU 502 directly rather than through memory bridge 505, and other devices would communicate with system memory 504 via memory bridge 505 and CPU 502. In other embodiments, parallel processing subsystem 512 may be connected to I/O bridge 507 or directly to CPU 502, rather than to memory bridge 505. In still other embodiments, I/O bridge 507 and memory bridge 505 may be integrated into a single chip instead of existing as one or more discrete devices. Lastly, in certain embodiments, one or more components shown in FIG. 5 may not be present. For example, switch 516 could be eliminated, and network adapter 518 and add-in cards 520, 521 would connect directly to I/O bridge 507.

FIG. 6 is a block diagram of a parallel processing unit (PPU) 602 included in the parallel processing subsystem 512 of FIG. 5, according to various embodiments. Although FIG. 6 depicts one PPU 602, as indicated above, parallel processing subsystem 512 may include any number of PPUs 602. As shown, PPU 602 is coupled to a local parallel processing (PP) memory 604. PPU 602 and PP memory 604 may be implemented using one or more integrated circuit devices, such as programmable processors, application specific integrated circuits (ASICs), or memory devices, or in any other technically feasible fashion.

In some embodiments, PPU 602 comprises a graphics processing unit (GPU) that may be configured to implement a graphics rendering pipeline to perform various operations related to generating pixel data based on graphics data supplied by CPU 502 and/or system memory 504. When processing graphics data, PP memory 604 can be used as graphics memory that stores one or more conventional frame buffers and, if needed, one or more other render targets as well. Among other things, PP memory 604 may be used to store and update pixel data and deliver final pixel data or display frames to an optional display device 510 for display. In some embodiments, PPU 602 also may be configured for general-purpose processing and compute operations. In some embodiments, computer system 500 may be a server machine in a cloud computing environment. In such embodiments, computer system 500 may not have a display device 510. Instead, computer system 500 may generate equivalent output information by transmitting commands in the form of messages over a network via the network adapter 518.

In some embodiments, CPU 502 is the master processor of computer system 500, controlling and coordinating operations of other system components. In one embodiment, CPU 502 issues commands that control the operation of PPU 602. In some embodiments, CPU 502 writes a stream of commands for PPU 602 to a data structure (not explicitly shown in either FIG. 5 or FIG. 6) that may be located in system memory 504, PP memory 604, or another storage location accessible to both CPU 502 and PPU 602. A pointer to the data structure is written to a command queue, also referred to herein as a pushbuffer, to initiate processing of the stream of commands in the data structure. In one embodiment, the PPU 602 reads command streams from the command queue and then executes commands asynchronously relative to the operation of CPU 502. In embodiments where multiple pushbuffers are generated, execution priorities may be specified for each pushbuffer by an application program via device driver to control scheduling of the different pushbuffers.

In one embodiment, PPU 602 includes an I/O (input/output) unit 605 that communicates with the rest of computer system 500 via the communication path 513 and memory bridge 505. In one embodiment, I/O unit 605 generates packets (or other signals) for transmission on communication path 513 and also receives all incoming packets (or other signals) from communication path 513, directing the incoming packets to appropriate components of PPU 602. For example, commands related to processing tasks may be directed to a host interface 606, while commands related to memory operations (e.g., reading from or writing to PP memory 604) may be directed to a crossbar unit 610. In one embodiment, host interface 606 reads each command queue and transmits the command stream stored in the command queue to a front end 612.

As mentioned above in conjunction with FIG. 5, the connection of PPU 602 to the rest of computer system 500 may be varied. In some embodiments, parallel processing subsystem 512, which includes at least one PPU 602, is implemented as an add-in card that can be inserted into an expansion slot of computer system 500. In other embodiments, PPU 602 can be integrated on a single chip with a bus bridge, such as memory bridge 505 or I/O bridge 507. Again, in still other embodiments, some or all of the elements of PPU 602 may be included along with CPU 502 in a single integrated circuit or system of chip (SoC).

In one embodiment, front end 612 transmits processing tasks received from host interface 606 to a work distribution unit (not shown) within task/work unit 607. In one embodiment, the work distribution unit receives pointers to processing tasks that are encoded as task metadata (TMD) and stored in memory. The pointers to TMDs are included in a command stream that is stored as a command queue and received by the front end unit 612 from the host interface 606. Processing tasks that may be encoded as TMDs include indices associated with the data to be processed as well as state parameters and commands that define how the data is to be processed. For example, the state parameters and commands could define the program to be executed on the data. Also for example, the TMD could specify the number and configuration of the set of CTAs. Generally, each TMD corresponds to one task. The task/work unit 607 receives tasks from the front end 612 and ensures that GPCs 608 are configured to a valid state before the processing task specified by each one of the TMDs is initiated. A priority may be specified for each TMD that is used to schedule the execution of the processing task. Processing tasks also may be received from the processing cluster array 630. Optionally, the TMD may include a parameter that controls whether the TMD is added to the head or the tail of a list of processing tasks (or to a list of pointers to the processing tasks), thereby providing another level of control over execution priority.

In one embodiment, PPU 602 implements a highly parallel processing architecture based on a processing cluster array 630 that includes a set of C general processing clusters (GPCs) 608, where C≥1. Each GPC 608 is capable of executing a large number (e.g., hundreds or thousands) of threads concurrently, where each thread is an instance of a program. In various applications, different GPCs 608 may be allocated for processing different types of programs or for performing different types of computations. The allocation of GPCs 608 may vary depending on the workload arising for each type of program or computation.

In one embodiment, memory interface 614 includes a set of D of partition units 615, where D≥1. Each partition unit 615 is coupled to one or more dynamic random access memories (DRAMs) 620 residing within PPM memory 604. In some embodiments, the number of partition units 615 equals the number of DRAMs 620, and each partition unit 615 is coupled to a different DRAM 620. In other embodiments, the number of partition units 615 may be different than the number of DRAMs 620. Persons of ordinary skill in the art will appreciate that a DRAM 620 may be replaced with any other technically suitable storage device. In operation, various render targets, such as texture maps and frame buffers, may be stored across DRAMs 620, allowing partition units 615 to write portions of each render target in parallel to efficiently use the available bandwidth of PP memory 604.

In one embodiment, a given GPC 608 may process data to be written to any of the DRAMs 620 within PP memory 604. In one embodiment, crossbar unit 610 is configured to route the output of each GPC 608 to the input of any partition unit 615 or to any other GPC 608 for further processing. GPCs 608 communicate with memory interface 614 via crossbar unit 610 to read from or write to various DRAMs 620. In some embodiments, crossbar unit 610 has a connection to I/O unit 605, in addition to a connection to PP memory 604 via memory interface 614, thereby enabling the processing cores within the different GPCs 608 to communicate with system memory 504 or other memory not local to PPU 602. In the embodiment of FIG. 6, crossbar unit 610 is directly connected with I/O unit 605. In various embodiments, crossbar unit 610 may use virtual channels to separate traffic streams between the GPCs 608 and partition units 615.

In one embodiment, GPCs 608 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 602 is configured to transfer data from system memory 504 and/or PP memory 604 to one or more on-chip memory units, process the data, and write result data back to system memory 504 and/or PP memory 604. The result data may then be accessed by other system components, including CPU 502, another PPU 602 within parallel processing subsystem 512, or another parallel processing subsystem 512 within computer system 500.

In one embodiment, any number of PPUs 602 may be included in a parallel processing subsystem 512. For example, multiple PPUs 602 may be provided on a single add-in card, or multiple add-in cards may be connected to communication path 513, or one or more of PPUs 602 may be integrated into a bridge chip. PPUs 602 in a multi-PPU system may be identical to or different from one another. For example, different PPUs 602 might have different numbers of processing cores and/or different amounts of PP memory 604. In implementations where multiple PPUs 602 are present, those PPUs may be operated in parallel to process data at a higher throughput than is possible with a single PPU 602. Systems incorporating one or more PPUs 602 may be implemented in a variety of configurations and form factors, including, without limitation, desktops, laptops, handheld personal computers or other handheld devices, servers, workstations, game consoles, embedded systems, and the like.

FIG. 7 is a block diagram of a general processing cluster (GPC) 608 included in the parallel processing unit (PPU) 602 of FIG. 6, according to various embodiments. As shown, the GPC 608 includes, without limitation, a pipeline manager 705, one or more texture units 715, a preROP unit 725, a work distribution crossbar 730, and an L1.5 cache 735.

In one embodiment, GPC 608 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 608. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

In one embodiment, operation of GPC 608 is controlled via a pipeline manager 705 that distributes processing tasks received from a work distribution unit (not shown) within task/work unit 607 to one or more streaming multiprocessors (SMs) 710. Pipeline manager 705 may also be configured to control a work distribution crossbar 730 by specifying destinations for processed data output by SMs 710.

In various embodiments, GPC 608 includes a set of M of SMs 710, where M≥1. Also, each SM 710 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 710 may be provided. In various embodiments, the functional execution units may be configured to support a variety of different operations including integer and floating point arithmetic (e.g., addition and multiplication), comparison operations, Boolean operations (AND, OR, 50R), bit-shifting, and computation of various algebraic functions (e.g., planar interpolation and trigonometric, exponential, and logarithmic functions, etc.). Advantageously, the same functional execution unit can be configured to perform different operations.

In various embodiments, each SM 710 includes multiple processing cores. In one embodiment, the SM 710 includes a large number (e.g., 128, etc.) of distinct processing cores. Each core may include a fully-pipelined, single-precision, double-precision, and/or mixed precision processing unit that includes a floating point arithmetic logic unit and an integer arithmetic logic unit. In one embodiment, the floating point arithmetic logic units implement the IEEE 754-2008 standard for floating point arithmetic. In one embodiment, the cores include 64 single-precision (32-bit) floating point cores, 64 integer cores, 32 double-precision (64-bit) floating point cores, and 8 tensor cores.

In one embodiment, tensor cores configured to perform matrix operations, and, in one embodiment, one or more tensor cores are included in the cores. In particular, the tensor cores are configured to perform deep learning matrix arithmetic, such as convolution operations for neural network training and inferencing. In one embodiment, each tensor core operates on a 4×4 matrix and performs a matrix multiply and accumulate operation D=A×B+C, where A, B, C, and D are 4×4 matrices.

In one embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use tensor cores from a CUDA-C++ program. At the CUDA level, the warp-level interface assumes 16×16 size matrices spanning all 32 threads of the warp.

Neural networks rely heavily on matrix math operations, and complex multi-layered networks require tremendous amounts of floating-point performance and bandwidth for both efficiency and speed. In various embodiments, with thousands of processing cores, optimized for matrix math operations, and delivering tens to hundreds of TFLOPS of performance, the SMs 710 provide a computing platform capable of delivering performance required for deep neural network-based artificial intelligence and machine learning applications.

In various embodiments, each SM 710 may also comprise multiple special function units (SFUs) that perform special functions (e.g., attribute evaluation, reciprocal square root, and the like). In one embodiment, the SFUs may include a tree traversal unit configured to traverse a hierarchical tree data structure. In one embodiment, the SFUs may include texture unit configured to perform texture map filtering operations. In one embodiment, the texture units are configured to load texture maps (e.g., a 2D array of texels) from memory and sample the texture maps to produce sampled texture values for use in shader programs executed by the SM. In various embodiments, each SM 710 also comprises multiple load/store units (LSUs) that implement load and store operations between the shared memory/L1 cache and register files internal to the SM 710.

In one embodiment, each SM 710 is configured to process one or more thread groups. As used herein, a “thread group” or “warp” refers to a group of threads concurrently executing the same program on different input data, with one thread of the group being assigned to a different execution unit within an SM 710. A thread group may include fewer threads than the number of execution units within the SM 710, in which case some of the execution may be idle during cycles when that thread group is being processed. A thread group may also include more threads than the number of execution units within the SM 710, in which case processing may occur over consecutive clock cycles. Since each SM 710 can support up to G thread groups concurrently, it follows that up to G*M thread groups can be executing in GPC 608 at any given time.

Additionally, in one embodiment, a plurality of related thread groups may be active (in different phases of execution) at the same time within an SM 710. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within the SM 710, and m is the number of thread groups simultaneously active within the SM 710. In some embodiments, a single SM 710 may simultaneously support multiple CTAs, where such CTAs are at the granularity at which work is distributed to the SMs 710.

In one embodiment, each SM 710 contains a level one (L1) cache or uses space in a corresponding L1 cache outside of the SM 710 to support, among other things, load and store operations performed by the execution units. Each SM 710 also has access to level two (L2) caches (not shown) that are shared among all GPCs 608 in PPU 602. The L2 caches may be used to transfer data between threads. Finally, SMs 710 also have access to off-chip “global” memory, which may include PP memory 604 and/or system memory 504. It is to be understood that any memory external to PPU 602 may be used as global memory. Additionally, as shown in FIG. 7, a level one-point-five (L1.5) cache 735 may be included within GPC 608 and configured to receive and hold data requested from memory via memory interface 614 by SM 710. Such data may include, without limitation, instructions, uniform data, and constant data. In embodiments having multiple SMs 710 within GPC 608, the SMs 710 may beneficially share common instructions and data cached in L1.5 cache 735.

In one embodiment, each GPC 608 may have an associated memory management unit (MMU) 720 that is configured to map virtual addresses into physical addresses. In various embodiments, MMU 720 may reside either within GPC 608 or within the memory interface 614. The MMU 720 includes a set of page table entries (PTEs) used to map a virtual address to a physical address of a tile or memory page and optionally a cache line index. The MMU 720 may include address translation lookaside buffers (TLB) or caches that may reside within SMs 710, within one or more L1 caches, or within GPC 608.

In one embodiment, in graphics and compute applications, GPC 608 may be configured such that each SM 710 is coupled to a texture unit 715 for performing texture mapping operations, such as determining texture sample positions, reading texture data, and filtering texture data.

In one embodiment, each SM 710 transmits a processed task to work distribution crossbar 730 in order to provide the processed task to another GPC 608 for further processing or to store the processed task in an L2 cache (not shown), parallel processing memory 604, or system memory 504 via crossbar unit 610. In addition, a pre-raster operations (preROP) unit 725 is configured to receive data from SM 710, direct data to one or more raster operations (ROP) units within partition units 615, perform optimizations for color blending, organize pixel color data, and perform address translations.

It will be appreciated that the architecture described herein is illustrative and that variations and modifications are possible. Among other things, any number of processing units, such as SMs 710, texture units 715, or preROP units 725, may be included within GPC 608. Further, as described above in conjunction with FIG. 6, PPU 602 may include any number of GPCs 608 that are configured to be functionally similar to one another so that execution behavior does not depend on which GPC 608 receives a particular processing task. Further, each GPC 608 operates independently of the other GPCs 608 in PPU 602 to execute tasks for one or more application programs.

In sum, the disclosed embodiments perform training-based quantization of weights and/or activation layers in a neural network and/or another type of machine learning model. The weights are quantized after forward-backward passes that update full-precision representations of the weights based on derivatives of a loss function for the neural network. Such weight quantization may additionally be performed based on an offset hyperparameter that delays quantization until a certain number of training steps have been performed and/or a frequency parameter that specifies the frequency with which quantization is performed after the delay. The activation layers are quantized in one or more stages, starting with layers closest to the input layers of the neural network and proceeding until layers closes to the output layers of the neural network are reached. When a given activation layer of the neural network is quantized, weights used to calculate inputs to the activation layer are frozen, and weights in subsequent layers of the neural network are fine-tuned based on the quantized outputs of the activation layer.

One technological advantage of the disclosed techniques is that quantization of full-precision weights in the neural network is performed after backpropagation is performed using a differentiable loss function, which can improve the accuracy of the neural network. Another technological advantage involves quantization of activation layers in the neural network separately from quantization of the weights and additional fine-tuning of weights in subsequent layers of the neural network based on the quantized activation layers, which may further improve the accuracy of the neural network during subsequent inference using the quantized values. Consequently, the disclosed techniques provide technological improvements in computer systems, applications, and/or techniques for reducing computational and storage overhead and/or improving performance during training and/or execution of neural networks or other types of machine learning models.

1. In some embodiments, a processor comprises one or more arithmetic logic units (ALUs) to perform one or more activation functions in a neural network using weights that have been converted from a first floating point value representation to a second floating point value representation having fewer bits than the first floating point value representation.

2. The processor of clause 1, wherein the one or more ALUs further perform one or more activation functions in the neural network by applying the weights to activation inputs that have been converted from the first floating point value representation to the second floating point value representation.

3. The processor of clauses 1-2, wherein the weights are converted by performing a first quantization of the weights from the first floating point value representation to the second floating point value representation after the weights are updated using a first number of forward-backward passes of training the neural network; and performing a second quantization of the weights from the first floating point value representation to the second floating point value representation after the weights are updated using a second number of forward-backward passes of training the neural network following the first quantization of the weight.

4. The processor of clauses 1-3, wherein the first number of forward-backward passes is determined based on an offset hyperparameter associated with training the neural network.

5. The processor of clauses 1-4, wherein the second number of forward-backward passes is determined based on a frequency hyperparameter associated with training the neural network.

6. The processor of clauses 1-5, wherein the weights are converted by freezing a first portion of the weights in a first one or more layers of the neural network; and modifying a second portion of the weights in a second one or more layers of the neural network.

7. The processor of clauses 1-6, wherein an output of the first one or more layers is quantized prior to modifying the second portion of the weights in the second one or more layers.

8. The processor of clauses 1-7, wherein the weights are converted by freezing the second portion of the weights in the second one or more layers of the neural network after the second portion of the weights is modified; and modifying a third portion of the weights in a third one or more layers of the neural network following the second one or more layers.

9. The processor of clauses 1-8, wherein modifying the second portion of the weights comprises updating the floating point values in the second portion of the weights based at least on an output of the first one or more layers; and converting the second portion of the weights from the first floating point value representation to the second floating point value representation.

10. In some embodiments, a method comprises training one or more neural networks, wherein training the one or more neural networks includes converting weight parameters from a first floating point value representation to a second floating point value representation having fewer bits than the first floating point value representation.

11. The method of clause 10, wherein converting the weight parameters comprises performing a first quantization of the weight parameters from the first floating point value representation to the second floating point value representation after the weight parameters are updated using a first number of forward-backward passes of training the one or more neural networks; and performing a second quantization of the weight parameters from the first floating point value representation to the second floating point value representation after the weight parameters are updated using a second number of forward-backward passes of training the one or more neural networks following the first quantization of the weight parameters.

12. The method of clauses 10-11, further comprising determining the first number of forward-backward passes based on an offset hyperparameter associated with the training of the one or more neural networks.

13. The method of clauses 10-12, further comprising determining the second number of forward-backward passes based on a frequency hyperparameter associated with the training of the one or more neural networks.

14. The method of clauses 10-13, wherein converting the weight parameters comprises freezing a first portion of the weight parameters in a first one or more layers of the one or more neural networks; and modifying a second portion of the weight parameters in a second one or more layers of the one or more neural networks that follow the first one or more layers.

15. The method of clauses 10-14, further comprising quantizing an output of the first one or more layers prior to modifying the second portion of the weight parameters in the second one or more layers.

16. The method of clauses 10-15, further comprising after the second portion of the weight parameters is modified, freezing the second portion of the weight parameters in the second one or more layers of the one or more neural networks; and modifying a third portion of the weight parameters in a third one or more layers of the one or more neural networks that follow the second one or more layers.

17. The method of clauses 10-16, wherein modifying the second portion of the weight parameters comprises updating the floating point values in the second portion of the weight parameters based at least on an output of the first one or more layers; and converting the second portion of the weight parameters from the first floating point value representation to the second floating point value representation.

18. The method of clauses 10-17, wherein the first one or more layers of the neural network comprise a convolutional layer, a batch normalization layer, and an activation layer.

19. The method of clauses 10-18, wherein the weight parameters are associated with a fully connected layer in the neural network.

20. In some embodiments, a system comprises one or more computers including one or more processors to train one or more neural networks, wherein training the one or more neural networks includes converting weight parameters from a first floating point value representation to a second floating point value representation having fewer bits than the first floating point value representation.

21. The system of clause 20, wherein converting the weight parameters comprises performing a first quantization of the weight parameters from the first floating point value representation to the second floating point value representation after the weight parameters are updated using a first number of forward-backward passes of training the one or more neural networks; and performing a second quantization of the weight parameters from the first floating point value representation to the second floating point value representation after the weight parameters are updated using a second number of forward-backward passes of training the one or more neural networks following the first quantization of the weight parameters.

22. The system of clauses 20-21, wherein the first number of forward-backward passes is based on an offset hyperparameter associated with the training of the one or more neural networks.

23. The system of clauses 20-22, wherein the second number of forward-backward passes is based on a frequency hyperparameter associated with the training of the one or more neural networks.

24. In some embodiments, a machine-readable medium has stored thereon a set of instructions, which if performed by one or more processors, cause the one or more processors to at least train one or more neural networks, wherein training the one or more neural networks includes converting weight parameters from a first floating point value representation to a second floating point value representation having fewer bits than the first floating point value representation.

25. The machine-readable medium of clause 24, wherein converting the weight parameters comprises performing a first quantization of the weight parameters from the first floating point value representation to the second floating point value representation after the weight parameters are updated using a first number of forward-backward passes of training the one or more neural networks; and performing a second quantization of the weight parameters from the first floating point value representation to the second floating point value representation after the weight parameters are updated using a second number of forward-backward passes of training the one or more neural networks following the first quantization of the weight parameters.

26. The machine-readable medium of clauses 24-25, wherein the first number of forward-backward passes is based on an offset hyperparameter associated with the training of the one or more neural networks.

27. The machine-readable medium of clauses 24-26, wherein the second number of forward-backward passes is based on a frequency hyperparameter associated with the training of the one or more neural networks.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A processor comprising:
one or more arithmetic logic units (ALUs) to perform one or more activation functions in a neural network using weights that have been converted from a first floating point value representation to a second floating point value representation having fewer bits than the first floating point value representation.

2. The processor of claim 1, wherein the one or more ALUs further perform one or more activation functions in the neural network by applying the weights to activation inputs that have been converted from the first floating point value representation to the second floating point value representation.

3. The processor of claim 1, wherein the weights are converted by:
performing a first quantization of the weights from the first floating point value representation to the second floating point value representation after the weights are updated using a first number of forward-backward passes of training the neural network; and
performing a second quantization of the weights from the first floating point value representation to the second floating point value representation after the weights are updated using a second number of forward-backward passes of training the neural network following the first quantization of the weight.

4. The processor of claim 3, wherein the first number of forward-backward passes is determined based on an offset hyperparameter associated with training the neural network.

5. The processor of claim 3, wherein the second number of forward-backward passes is determined based on a frequency hyperparameter associated with training the neural network.

6. The processor of claim 1, wherein the weights are converted by:
freezing a first portion of the weights in a first one or more layers of the neural network; and
modifying a second portion of the weights in a second one or more layers of the neural network.

7. The processor of claim 6, wherein an output of the first one or more layers is quantized prior to modifying the second portion of the weights in the second one or more layers.

8. The processor of claim 6, wherein the weights are converted by:
after the second portion of the weights is modified, freezing the second portion of the weights in the second one or more layers of the neural network; and
modifying a third portion of the weights in a third one or more layers of the neural network following the second one or more layers.

9. The processor of claim 6, wherein modifying the second portion of the weights comprises:
updating the floating point values in the second portion of the weights based at least on an output of the first one or more layers; and
converting the second portion of the weights from the first floating point value representation to the second floating point value representation.

10. A method, comprising:
training one or more neural networks, wherein training the one or more neural networks includes converting weight parameters from a first floating point value representation to a second floating point value representation having fewer bits than the first floating point value representation.

11. The method of claim 10, wherein converting the weight parameters comprises:
performing a first quantization of the weight parameters from the first floating point value representation to the second floating point value representation after the weight parameters are updated using a first number of forward-backward passes of training the one or more neural networks; and
performing a second quantization of the weight parameters from the first floating point value representation to the second floating point value representation after the weight parameters are updated using a second number of forward-backward passes of training the one or more neural networks following the first quantization of the weight parameters.

12. The method of claim 11, further comprising:
determining the first number of forward-backward passes based on an offset hyperparameter associated with the training of the one or more neural networks.

13. The method of claim 11, further comprising:
determining the second number of forward-backward passes based on a frequency hyperparameter associated with the training of the one or more neural networks.

14. The method of claim 10, wherein converting the weight parameters comprises:
freezing a first portion of the weight parameters in a first one or more layers of the one or more neural networks; and
modifying a second portion of the weight parameters in a second one or more layers of the one or more neural networks that follow the first one or more layers.

15. The method of claim 14, further comprising quantizing an output of the first one or more layers prior to modifying the second portion of the weight parameters in the second one or more layers.

16. The method of claim 14, further comprising:
after the second portion of the weight parameters is modified, freezing the second portion of the weight parameters in the second one or more layers of the one or more neural networks; and
modifying a third portion of the weight parameters in a third one or more layers of the one or more neural networks that follow the second one or more layers.

17. The method of claim 14, wherein modifying the second portion of the weight parameters comprises:
updating the floating point values in the second portion of the weight parameters based at least on an output of the first one or more layers; and
converting the second portion of the weight parameters from the first floating point value representation to the second floating point value representation.

18. The method of claim 14, wherein the first one or more layers of the neural network comprise a convolutional layer, a batch normalization layer, and an activation layer.

19. The method of claim 10, wherein the weight parameters are associated with a fully connected layer in the neural network.

20. A system comprising:
one or more computers including one or more processors to train one or more neural networks, wherein training the one or more neural networks includes converting weight parameters from a first floating point value representation to a second floating point value representation having fewer bits than the first floating point value representation.

21. The system of claim 20, wherein converting the weight parameters comprises:
performing a first quantization of the weight parameters from the first floating point value representation to the second floating point value representation after the weight parameters are updated using a first number of forward-backward passes of training the one or more neural networks; and
performing a second quantization of the weight parameters from the first floating point value representation to the second floating point value representation after the weight parameters are updated using a second number of forward-backward passes of training the one or more neural networks following the first quantization of the weight parameters.

22. The system of claim 21, wherein the first number of forward-backward passes is based on an offset hyperparameter associated with the training of the one or more neural networks.

23. The system of claim 21, wherein the second number of forward-backward passes is based on a frequency hyperparameter associated with the training of the one or more neural networks.

24. A machine-readable medium having stored thereon a set of instructions, which if performed by one or more processors, cause the one or more processors to at least:
train one or more neural networks, wherein training the one or more neural networks includes converting weight parameters from a first floating point value representation to a second floating point value representation having fewer bits than the first floating point value representation.

25. The machine-readable medium of claim 24, wherein converting the weight parameters comprises:
performing a first quantization of the weight parameters from the first floating point value representation to the second floating point value representation after the weight parameters are updated using a first number of forward-backward passes of training the one or more neural networks; and
performing a second quantization of the weight parameters from the first floating point value representation to the second floating point value representation after the weight parameters are updated using a second number of forward-backward passes of training the one or more neural networks following the first quantization of the weight parameters.

26. The machine-readable medium of claim 25, wherein the first number of forward-backward passes is based on an offset hyperparameter associated with the training of the one or more neural networks.

27. The machine-readable medium of claim 25, wherein the second number of forward-backward passes is based on a frequency hyperparameter associated with the training of the one or more neural networks.
